(19) United States
(12) Patent Application Publication
(10) Pub. No.: US 2021/0142350 A1
(43) Pub. Date: May 13, 2021

(54) METHOD FOR BUYING A DIGITAL COUPON AND SENDING IT TO ANOTHER USER

(71) Applicant: LIMITED LIABILITY COMPANY "GMOJ", Ekaterinburg (RU)

(72) Inventors: Nikolaj Vakorin, Ekaterinburg (RU); Roman Kneller, Ekaterinburg (RU)

(21) Appl. No.: 17/048,599

(22) PCT Filed: Jul. 3, 2018
(86) PCT No.: PCT/RU2018/000257

§ 371 Date: Oct. 18, 2020

(30) Foreign Application Priority Data
Apr. 19, 2018 (RU) 2018114501

(51) Int. Cl. G06Q 30/02

(52) U.S. Cl. CPC G06Q 30/0213; G06K 7/1417; G06Q 30/0225

(57) ABSTRACT

The objective of the present invention is to speed up selling of goods/services by transferring the right of receiving said goods/services via communication means; to expand technical means; to enable users to send goods/services to other people via electronic communication means, as well as get said goods/services from one or more sellers (service providers) and choose between them, without being restricted to one region (city). Besides, the present solution provides better protection for the right to receive goods with a PIN code (for activation), which allows to prevent digital coupons from being used by unintended people or unscrupulous sellers, e.g. by photographing its QR code or bar code. The objective is related to sending and receiving goods using electronic communication means and requires technical solution, wherein no alternative means can be used to achieve the same.

### CROSS-REFERENCE

The present application claims priority to Russian Patent Application No. 2018114501, filed on Apr. 19, 2018, entitled “METHOD FOR BUYING A DIGITAL COUPON AND SENDING IT TO ANOTHER USER” the entirety of which is incorporated herein by reference and is a continuation of PCT/RU2018/000257, filed on Jul. 3, 2018, entitled “METHOD FOR BUYING A DIGITAL COUPON AND SENDING IT TO ANOTHER USER”.

### FIELD

The present invention relates to methods and systems for transferring an open bearer negotiable electronic document entitling the bearer to claim some goods.

### BACKGROUND

Nowadays, services that allow users to give gifts to each other are becoming increasingly popular.

Such conventional services, that are designed to give virtual gifts to one's friends, are implemented in a variety of social networks, such as VKontakte or Odnoklassniki. The drawback of such conventional solutions is they cannot be used to give real-world gifts, e.g. goods or services.

Another conventional solution is to order delivery of a gift from the person making a gift to the person receiving the gift. Yet, this solution is not always convenient, since such deliveries have to be arranged beforehand, and some goods or services cannot be delivered at all.

### SUMMARY

The objective of the present technical solution is to speed up selling of goods/services by transferring the right of receiving said goods/services via communication means; to expand technical means; to enable users to send goods/services to other people via electronic communication means, as well as get said goods/services from one or more sellers (service providers) and choose between them, without being restricted to one region (city). Besides, the present solution provides better protection for the right to receive goods with a PIN code (for activation), which allows to prevent digital coupons from being used by unintended people or unscrupulous sellers, e.g. by photographing its QR code or bar code.

The objective is related to sending and receiving goods using electronic communication means and requires technical solution, wherein no alternative means can be used to achieve the same.

In an exemplary embodiment, the method for buying a digital coupon and sending it to another user comprises the following steps:
on the first user's device, receiving the information on selection of an additional keyboard in a messaging application (MSGAPP) that enables the user to send digital coupons via a connected digital coupon management application (COUPONAPP);
on the first user's device, receiving the information on selecting some goods or services with said keyboard, to buy a digital coupon that the user wants to send via their messaging application (MSGAPP);
paying for the goods or services via the COUPONAPP application on the mobile device, using a payment service, wherein the service notifies a server of a successful payment, then the server generates a digital coupon for the goods or services thus bought, stores the data required for sending the digital coupon, and sends these data to the first user's mobile device, into their COUPONAPP application, which, in turn, generates a link, based on the data received, the link connected to the generated digital coupon, and then the generated digital coupon link is sent via the messaging application (MSGAPP);
the second user receiving the digital coupon link via their MSGAPP application, either on a computer or a mobile device, viewing the coupon data and then providing the seller of the goods or services associated with the digital coupon, with the data required to activate the coupon and sell said goods or services; and
the seller inputting the data required to activate the coupon, into a seller's device, which, in turn, sends these data to a server, then the server marks the digital coupon as activated and sends a notification of a successful coupon activation back to the seller's device, and finally, the seller sells the goods or services associated with the digital coupon.

In an exemplary embodiment, the method for buying a digital coupon and sending it to another user comprises the following steps:
selecting an additional keyboard in a messaging application (MSGAPP), wherein the keyboard enables the first user to send digital coupons from their mobile device using a digital coupon management application (COUPONAPP) that is linked to the keyboard;
with said additional keyboard, selecting goods or services to buy a digital coupon for, that the user wants to send via the messaging application (MSGAPP);
paying for the goods or services via the COUPONAPP application on the mobile device, using a payment service, wherein the service notifies a server of a successful payment, then the server generates a digital coupon for the goods or services thus bought, stores the data required for sending the digital coupon, and sends these data to the first user's mobile device, into their COUPONAPP application, which, in turn, generates a link, based on the data received, the link connected to the generated digital coupon, and then the generated digital coupon link is sent via the messaging application (MSGAPP);
the second user receiving the digital coupon link via their MSGAPP application, either on a computer or a mobile device, then following this link to view the coupon data and possible places where the goods or services associated with the digital coupon can be obtained, and then providing the seller of said goods or services with the data required to activate the coupon and sell said goods or services; and
the seller inputting the data required to activate the coupon, into a seller's device, which, in turn, sends these data to a server, then the server marks the digital coupon as activated and sends a notification of a successful coupon activation back to the seller's device, and finally, the seller sells the goods or services associated with the digital coupon.

### BRIEF DESCRIPTION OF THE ATTACHED FIGURES

The objects, features and advantages of the technical solution will be further pointed out in the detailed description as well as the appended drawings. In the drawings:

FIG. 1 shows an exemplary embodiment of the present invention.

FIG. 2 shows the process of the user selecting an additional keyboard in a mobile messaging application.

FIG. 3 is an exemplary illustration of displaying symbols for goods categories and goods corresponding to digital coupons.

FIG. 4 shows an exemplary screen where the user interacts with their bank card.

FIG. 5 is an exemplary illustration of a digital coupon sent to a digital coupon receiver via a messaging application.

FIG. 6 is an exemplary illustration of a digital coupon and how it is displayed to the user (receiver) in a message in the messaging application.

FIG. 7 shows a screen for viewing digital coupons.

FIG. 8 is an exemplary illustration of mobile application screens for sending digital coupons that has been received by the user (receiver).

FIG. 9 shows an example of a double-sided field.

FIG. 10 shows a screen with a list of goods in a mobile application.

FIG. 11 shows a screen that displays the goods in a mobile application.

FIG. 12 shows screens that display payment system messages to the user.

FIG. 13 shows a screen for sending digital coupons.

FIG. 14 shows an exemplary embodiment of the system to carry out the method of the present invention.

FIG. 15 is an exemplary illustration of how the present system can be integrated with a payment service (payment system).

### DETAILED DESCRIPTION

Objects and features of the present technical solution, methods for achieving these objects and features will become apparent by reference to the exemplary embodiments. However, the present invention is not limited to the exemplary embodiments disclosed below; it may be embodied in various forms. Summary contained in the description, is nothing but specific details secured to aid those skilled in the art in a comprehensive understanding of the invention, and the present invention is only defined within the scope of the appended claims.

The terms “module”, “component”, “element”, etc. mentioned in the present disclosure are used to denote computer-related entities, such as hardware (e.g. a device, an instrument, an apparatus, a piece of equipment, a constituent part of a device, e.g. a processor, a microprocessor, an integrated circuit, a printed circuit board (PCB), including printed wiring boards, a breadboard, a motherboard, etc., a microcomputer, etc.), software (e.g. executable programming code, a compiled application, a program module, a part of software or programming code, etc.), and/or firmware. For instance, a component may be a processor-executed process, an object, executable code, programming code, a file, a program/an application, a function, a method, a (program) library, a sub-program, a co-program, and/or a computing device (e.g. a microcomputer or a computer), or a combination of software or hardware components. Thus, an application run on a server, in an exemplary case, may be a component/module, while the server may be a component/module. Please note that at least one component/module may be a part of a process. Components/modules may be located in a single computing device (e.g. a microcomputer, a microprocessor, a PCB, etc.) and/or distributed/divided among several computing devices.

FIG. 1 is a flowchart illustrating an exemplary embodiment of the present invention.

According to the present invention, the first user (sender) installs a mobile application (COUPONAPP) on a mobile device, particularly, the user's (sender's) mobile device 1412. In an exemplary embodiment of the present invention, users include both senders (aka buyers of digital coupons) and (or) receivers of digital coupons.

When the application is installed, an additional keyboard is also added to the user device, wherein the keyboard is connected to the COUPONAPP application. Said additional keyboard is an extension (particularly, a module) to the mobile application (COUPONAPP). Said additional keyboard is able to function only if the mobile application is installed on the user device (mobile application user device), wherein the keyboard acts as an interface that is connected to the components of the claimed system of the present invention via the mobile application.

Then, the user launches a messaging application on their mobile device.

Then, in said messaging application, the user switches from a standard keyboard to the additional keyboard, as shown in FIG. 2.

Then, the mobile application (COUPONAPP) is launched on the user device in background mode.

Then, mobile application (COUPONAPP) means authorize the user in the mobile application.

Then, the messaging application displays visual symbols (images, particularly, icons) that represent goods categories or goods (corresponding to digital coupons), for which the user has bought digital coupons and which, therefore, can be purchased (as described in the present disclosure). Digital coupons that have been bought can be displayed, as shown in FIG. 3.

Then, the user selects goods symbols using the additional keyboard, after which the user initiates payment to automatically buy some goods (corresponding to the selected symbol), provided that user's data are stored in the payment service. In an exemplary embodiment, the payment system (payment service) receives a request to withdraw some money from the user's account using the payment system (service) API.

Please note that a bank card can be linked to the payment system (payment service), e.g. Visa, MasterCard, AmericanExpress, or authorized partners, such as Cloud Payments Payture, Apple Pay, Samsung Pay, Yandex.Money, etc., via the user profile screen in the mobile application. After the user has provided their bank card details and personal data (particularly, cardholder name), the mobile application (COUPONAPP) sends these data (via the payment system's API) to the payment system server to verify the bank card number, details, expiry date, etc.

In an exemplary embodiment, if the user's data are not stored in the payment service, then, after the user has selected some goods using the additional keyboard and the payment has been initiated, the user is redirected to a screen (page) in the mobile application designed for user's interactions with their bank cards (bank card operations, specifically, buying goods and generating digital coupons for goods or services bought), particularly, via a built-in component that is configured to integrate web pages into mobile applications (such as WebView, for instance), as shown in FIG. 4.

After the user has inputted their bank card details and personal data, and has clicked the “Pay” button, then, if everything is correct, a notification message (window) is displayed telling the user that the payment for goods or services (associated with a digital coupon) has been successful, e.g. “Payment complete”.

Then, the necessary amount of money on the bank card (bank account) is reserved by the payment system, and the server (see 1422 in FIG. 14) receives a corresponding message (notification) that said amount of money has been successfully reserved.

Then, the server 1422 sends a command to withdraw the given amount of money from the user's (sender's) bank card, as shown in FIG. 15.

Then, the server 1422 generates a digital coupon, and the mobile application generates a short link that would identify the mobile application, particularly, the coupon sender, and/or the user's mobile device (specifically, the sender's mobile device). While the digital coupon is being generated, the server 1422 also generates a digital coupon ID, a PIN code (used to activate the coupon), and a digital code (used to activate the coupon), particularly, a QR code and/or bar code corresponding to a seller/sellers, which can be scanned/photographed at the place of sale of the goods or services, specifically, by the seller (or their representative) using a dedicated device, such as a bar code or QR code scanner, or the built-in camera of a mobile device. Besides, in some embodiments, the digital coupon contains (unix timestamp) a current date tag (buy_date) and a number of days left (expiration_days).

In some embodiments, PIN code contains four symbols (in other embodiments, it may contain five, six or more symbols); it may be a number or a combination of letters and digits (e.g. 1234) that is generated randomly (using random number generation means, such as Randomizer).

When a digital coupon is generated, it is also linked (“attached”) to at least one seller using the digital coupon ID.

In an exemplary embodiment, when the digital coupon is generated, the server 1422 receives the information on goods or services (particularly, their prices, descriptions, etc.) from the goods and services database, particularly, the seller(s)'s database, and links this information to the digital coupon. In some embodiments, the information from the goods and services database includes:
image of goods or a service (a default image, or, if unavailable, a scaled-up image of their symbols in the application);
name of goods or a service;
full description.

In an exemplary embodiment of the present invention, the database 1424 may be stored on the server 1422, or in a separate data storage.

In some embodiments, the data storage may be represented by at least one hard-disk drive (HDD), a solid-state drive (SSD), a Storage Area Network (SAN), a Network Attached Storage (NAS), and/or any other device configured to write, read and/or store data on a device that implements the data storage.

In some embodiments, the database may be hierarchical, object, object-oriented, object-relational, relational, centralized, fragmented/partitioned, replicated, spatial, etc.

In some embodiments, various database management systems (DBMS) may be used to manage, create and operate the databases.

Then, the number of goods bought by the user, that are associated with digital coupons, is increased, and said number of digital coupons is displayed on the goods and services symbols on the additional keyboard. Please note that the number of goods bought by the user is stored on the server 1422, or it may be cached on the user's mobile device.

Then, the link to the generated digital coupon associated with the goods or services that have been bought (or received by the user as a gift from another user) is copied into the text input field in the messaging application. Then, the digital coupon with said link is displayed in the mobile messaging application (MSGAPP), as shown in FIG. 5.

Then, the user (sender) sends the digital coupon to the other user (receiver) by clicking the “Send” button in the messaging application. Please note that in case the user has bought multiple digital coupons associated with particular goods or services, the coupon with the earliest expiration date is sent first.

In an exemplary embodiment of the present invention, if the user (sender) has bought (purchased) multiple goods or services associated with digital coupons, wherein several digital coupons have the same expiration date, then the first digital coupon from the coupon list is sent, based on its buy date and its ID number.

In some embodiments, the identifier (ID number) is a unique number, which is automatically generated (created) by the server (or the database upon adding a new entry).

In some embodiments, the identifier (ID number) is a 16-symbol combination of letters and digits.

In some embodiments, the identifier (ID number) is at least 6 symbols long.

The number of digital coupons that are ready to be sent, is decreased (upon refreshing the data). After the user (sender) has sent a digital coupon to the other user (receiver), the server 1422 decreases the number of goods or services bought by the user (sender) by one. Next, the digital coupon with the earliest expiration date is queued to be sent by the user (sender).

Then, the other user (receiver) receives the digital coupon from the user (sender) via the messaging application (COUPONAPP).

Then, the digital coupon is displayed to the user (receiver) in a message in the messaging application as a visual symbol of some goods or services (particularly, of the digital coupon), as shown in FIG. 6.

Then, the digital coupon is displayed when selected by the user (using a mouse or a touchscreen of the mobile device, etc.) or when clicked by the user (receiver).

In an exemplary embodiment, if the user (receiver) has the mobile application (COUPONAPP) installed, then, when the user selects the visual representation of the goods or services, their mobile device starts (particularly, launches) the mobile application showing the digital coupon viewing screen, as shown in FIG. 7. In an exemplary embodiment, if the mobile device of the user (receiver) does not have the mobile application installed, then the user may be shown a screen with the two following options:
“Send via the mobile application”, i.e. the user's mobile device will open an electronic application store, from which the mobile application can be downloaded, as shown in FIG. 8; and
“View”, i.e. the digital coupon will be displayed to the user (receiver) as an image (without installing the mobile application).

In some embodiments, the electronic store is a standard tool provided by the operating system of the mobile device, such as Google Play Market, Apple Store, etc.

Then, the user (receiver) buys/purchases the goods or services associated with the received digital coupon.

In exemplary embodiments of the present invention, the activated code of a digital coupon may be displayed as one of the following (particularly, depending on goods or services settings):
QR code;
bar code; or
digital code.

In an exemplary embodiment, the reception of the goods or services with the digital coupon, particularly, the activation of the digital coupon, is registered by the seller using a corresponding device, which, for instance, is capable of registering the fact that the user has obtained dedicated goods or services.

Bar codes, QR codes, or digital codes (hereinafter referred to as “codes”) are read by a device (belonging to the seller or service provider representative) that is capable of scanning the codes (or, in some embodiments, photograph the codes) that are disclosed therein, or codes are inputted using the keyboard.

Digital coupons may be activated in one of the following ways, or by a combination thereof:
from the digital coupon page in the mobile application (by scanning/photographing the code, or by inputting the digital code of goods of services);
from the digital coupon web page, particularly, by scanning/photographing any code disclosed herein, or by inputting the (digital) code of the goods or services associated with the coupon;
from another application or program that is installed on the desktop or mobile device of the seller/provider; or
by using the digital code in a phone call (“Call from mobile application/Order delivery”). In the claimed embodiment of the present invention, the “Call from mobile application/Order delivery” button is also associated with the seller's delivery service phone number. By clicking said button, the user (receiver) device automatically dials the number.

In an exemplary embodiment of the present invention, the digital code is a digital coupon number.

In an exemplary embodiment of the present invention, the digital coupon number is a bar code or QR code (a link) conforming to the RFC4122 standard, in the form of 151B-090X-090A-2556, wherein such codes are generated in accordance with the V4 algorithm (https://www.npmjs.com/package/uuid).

In other exemplary embodiments, other bar code generation algorithms may be used, including those not mentioned herein.

In some embodiments, the digital code may be activated remotely, when the user orders the goods or services to be delivered to them. For instance, the seller may input the digital code on the digital coupon activation page (e.g. web page) in the seller's dashboard on the web site, or otherwise.

In some embodiments, the digital code may be used for the “Incoming call/Order a call” option, wherein when the user clicks the “Incoming call/Order a call” button, a form containing the following fields is displayed (said fields are generated by the server 1422, particularly, as the digital coupon is being generated):
digital coupon number, wherein the number is automatically filled;
return call number, where the user inputs their phone number (mobile phone, cell phone, landline, etc.);
seller selection, where the user may select one seller from the list of sellers that sell the goods or services associated with the digital coupon (for instance, if said goods or services are sold by one seller only, then this field is automatically filled with the seller's name, particularly, their ID number, etc.); and
a message to the seller.

In some embodiments, the digital code may be activated by the seller remotely. In an exemplary embodiment, the seller inputs the digital code on the digital coupon activation page (screen) in the seller's dashboard, or otherwise.

According to FIG. 1, an exemplary embodiment of the claimed method comprises the following steps:

In step 110, the first user (sender) selects an additional keyboard in the mobile messaging application, wherein the keyboard enables the first user to send digital coupons from their mobile device using a digital coupon management application that is linked to the keyboard.

In some embodiments, messaging applications may include, but are not limited to, WhatsApp, Viber, Telegram, WeChat, Facebook Messenger, etc.

In some embodiments, messaging applications may include, but are not limited to, e-mail. In some embodiments, e-mail may be implemented as an independent application, such as Outlook, Inbox, or Gmail. In some embodiments, e-mail may be accessed through the device's web browser, such as Google Chrome, Puffin, Safari, Firefox, etc.

In some embodiments, messaging applications may include, but are not limited to, SMS or MMS.

In step 120, the first user selects some goods or services with said keyboard, to buy a digital coupon that the first user wants to send to the second user via the messaging application.

In step 130, the user pays for the selected goods or services on their mobile device using the mobile application connected to a payment service. The mobile device sends payment information for the selected goods or services to the payment service, which, in turn, verifies whether the payment can be carried out, and notifies the server 1422 if the payment has been successful. Then, the server 1422 generates a digital coupon for the purchased goods or services, stores the data required to send the coupon in the database and sends the data to the first user's mobile device via the mobile application, which generates a link connected to the generated digital coupon, based on the received data, and then sends the digital coupon link via the messaging application. All necessary data including, but not limited to, payment status, price, selected items, order time, and user name, is stored on the server and may be used for additional verification.

In step 140, the second user (receiver) receives the digital coupon link, either on a computer or a mobile device, then follows this link to view the coupon data and possible places where the goods or services associated with the digital coupon can be obtained, and then provides the seller of said goods or services with the data required to activate the coupon and sell said goods or services.

In some embodiments, the second user receives the digital coupon link via their mobile application.

In some embodiments, the second user receives the digital coupon link by e-mail.

In some embodiments, the second user receives the digital coupon link via SMS or MMS. In some embodiments, the displayed coupon information may contain:
a double-sided field with the information about goods;
a “Send” button to select the method of sending the digital coupon;
a city name field;
a map listing places where the goods or services can be received (those nearest to the user, if any); and
other fields and details.

In an exemplary embodiment, said double-sided field (as shown in FIG. 9) contains:
on one side of the digital coupon:
   image of goods or a service (a default image, or, if unavailable, a scaled-up image of their rendering in the application);
   name of goods or a service;
   full description;
on the other side of the digital coupon:
   a rendering of goods or a service;
   visual representation of the digital coupon code (various options);
   digital representation of the digital coupon code;
   PIN code used to activate the digital coupon (or its seller's code);
      digital coupon life; and
   other fields and details.

In some embodiments, the PIN code contains four symbols.

In some embodiments, the PIN code contains five or six symbols.

In some embodiments, the PIN code is a four-digit number (e.g. 1234) that is generated randomly (using random number generation means).

In some embodiments, the PIN code contains both letters and digits.

In step 150, the seller of goods or services inputs the data required to activate the coupon into their computer or mobile device (seller's device), which then sends this data to the server 1422. The server 1422 receives the data required to activate the coupon, validates them, and, if the validation is successful, marks the digital coupon as activated, and then notifies the seller's device of successful activation. Then, the seller sells the goods or services associated with the digital coupon.

If the validation failed, the server sends an error notification to the seller's device.

In some embodiments, the information on places, where the goods or services may be obtained, may be presented as an interactive map. For instance, said interactive map may contain the user's city and pins marking seller's locations (particularly, seller terminals 1420) in this city.

In some embodiments of the present invention, when the user (either sender or receiver of goods or services) clicks or taps a seller's location on the map, its address is displayed to the user.

In some embodiments of the present invention, goods or services belonging to multiple sellers may be displayed to the user, wherein if some goods or services (specifically, those associated with digital coupons, as disclosed herein) can be sold by multiple sellers, then the interactive map will contain locations (seller terminals 1420) of all sellers that sell said goods or services.

In an exemplary embodiment, after buying some goods or services, the user may view the goods and services they have bought, provided their digital coupons have been generated. Said goods and services are displayed in the mobile application menu (screen), in the “My Gifts” folder (actual name of the folder and its position on the mobile application screen may vary).

In some embodiments (see FIG. 16), after the user (sender) has bought the goods, the application will display the life of the digital coupon (specifically, the time period, during which the coupon is valid and, particularly, can be sent to the other user (receiver)), either on the coupon image or adjacent to it, wherein the coupon life may be displayed as a difference between the buy date and expiration date (remaining time until the coupon is activated by the other user), aka “delta”.

In an exemplary embodiment of the present invention, digital coupons have same lifetime for all users (both senders and/or receivers), which, for instance, may be calculated (counted) by the server according to Moscow time, wherein the remaining life of coupons in the mobile application will be supplemented with a corresponding clarification (e.g. “Moscow time). Also, this clarification may be modified, e.g. depending on the server 1422 location, the region where the goods or services are provided, or the user's (sender or receiver) location.

In an exemplary embodiment (see FIG. 17), if said “delta” exceeds one day (24 h), then the remaining life of a digital coupon is displayed in days, rounded down. For instance, if a digital coupon expires in 10 days, 5 hours and 7 minutes, then the user (for instance, the receiver) is notified that they have to use the coupon within 10 days, e.g. “Expires in 10 days”.

In an exemplary embodiment, if said “delta” is less than one day, then the remaining life of a digital coupon is displayed in hours and minutes.

In an exemplary embodiment (see FIG. 18), if the activation period of a digital coupon has expired (“delta” is less than zero), then the user is notified (e.g. by a message) that the coupon has expired, and thus, for instance, can't be sent by the user (sender) to the other user (receiver), or it can't be activated by that other user (receiver). For instance, one of the users may receive the following notification: “You digital coupon has expired”.

In some embodiments, the digital coupons stored in the “My Gifts” menu in the mobile application (COUPONAPP) may be divided in at least two groups, such as “My Coupons” and “Sent Coupons”.

In an exemplary embodiment of the present invention, digital coupons sent by the user (sender) to the other user (receiver), who is not registered in the mobile application, are not displayed on the “My Gifts” screen (window). Please note that when a digital coupon is sent to multiple users, who are registered in the mobile application, then the user who has opened the link to the coupon last, is considered the receiver of the digital coupon.

Please note that digital coupons may be sent not only using the additional keyboard in the messaging application, but also via the mobile application.

Also note that windows in the mobile application may include the upper part of the mobile application screen, where goods and services categories are displayed.

In an exemplary embodiment of the present invention, goods and services categories are located in the upper part of the mobile application screen. Also, said categories are represented by names of corresponding goods or services, as well as visual representations, such as thumbnails, icons, etc., which, in an exemplary embodiment, may act as activated interface elements in the mobile application. Said elements of goods and services categories may be displayed in at least one line. To browse through said categories, the mobile application user may horizontally scroll through the elements of said categories. Please note that, in an exemplary embodiment, the category, that has been placed by the user in the center (into the middle of the category line), is considered to be selected.

Please note that in an exemplary embodiment of the present invention, the user may browse through goods and services categories in the mobile application in the following ways:
by selecting the symbol corresponding to the required goods or services;
by selecting the name of the required goods or services category;
by horizontally scrolling the list of categories (in the upper part of the mobile application screen); or
by a horizontal finger movement (swipe), particularly, in the lower part of the mobile application screen (window).

By browsing through goods or services categories as described above, the user may view all goods or services available in the selected category.

Please note that said goods or services may occupy up to two lines, wherein extra text is replaced with “. . . ”.

In an exemplary embodiment of the present invention, the list of goods or services in the selected category is located beneath the category selection field. The goods or services category screen contains the list of all goods or services in the selected category, as well as their detailed information, such as:
image of goods or a service;
name of goods or a service; and
price of goods or a service (particularly, associated with a digital coupon).

In an exemplary embodiment, if certain goods or services are currently unavailable to buy (e.g. the client has no Internet connection), particularly, no digital coupon can be generated for those goods or services, then, after the user clicks the “Buy” button, the application displays a pop-up window notifying the user that the goods or services can't be bought.

Please note that list items on the screen may occupy two lines. Also, the user may scroll the list vertically. For instance, if there are less than six visual representations of goods, they are filled in one by one, starting from the upper left corner (from right to left, from top to down), as shown in FIG. 10.

In an exemplary embodiment, the “Goods/services card” screen is displayed after the user (sender) has selected some goods or services. Said screen may contain, for example, the following:
a double-sided field containing information about goods or services (in some embodiments, a single-sided field may be user);
name (title, ID, etc.) of the seller, and seller's information;
a field for inputting the city name (for instance, it may contain a default city name); and
a map listing places where the goods or services can be received, particularly, those nearest to the user, if any.

In an exemplary embodiment, said double-sided field may contain:
on one side of the double-sided field:
   image of goods or a service (a default image, or, if unavailable, a scaled-up image of their rendering in the mobile application); and
   name of goods or a service;
on the other side of the double-sided field:
   name of goods or a service;
   price of goods or a service;
   a rendering of goods or a service;
   detailed description of goods or a service; and
   a “Buy” button.

In an exemplary embodiment, when buying a digital coupon, the user (sender) buys a single item of goods or services.

In some embodiments, when viewing the goods, the double-sided field turns around to notify the user that they have to fill out the reverse side of the field.

When the user clicks the “Buy” button on the goods or service display screen (as shown in FIG. 11), payment is initiated.

After successful initiation, a bank card form is displayed to the user (sender), who is making the purchase. Then, after the user has clicked the “Pay” button, provided they have provided correct bank card retails, a payment notification is displayed to the user (e.g. “Payment complete”). Please note that the payment notification is displayed for some pre-set time, e.g. 3 sec, while the payment system (payment service) contacts the server 1422, particularly, by sending a request, to notify it of successful reservation of money on the user's bank card.

After the server 1422 has received the notification of successful money reservation, the server 1422 withdraws the given amount of money from the user's bank card and creates (generates) a digital coupon. The mobile application notifies the user (in a window) that the digital coupon is being generated (e.g. “Please wait, your digital coupon is being generated”) while the money is being withdrawn from their bank card and the coupon is being generated.

Then, after the goods or service has been successfully paid for and the digital coupon has been created, the mobile application (automatically) displays the “My Gifts” screen to the user, where, according to an exemplary embodiment, the digital coupon just bought is shown first.

Please note that, in an exemplary embodiment, buying a single digital coupon means buying a single item of goods or services.

Also note that in case the digital coupon has not been generated within a certain (pre-set) amount of time, e.g. 40 sec, then the mobile application notifies the user that the coupon creation failed (e.g. “Something went wrong. For help, please contact us via e-mail: <address>.”), the notification window containing the “Close” button.

When making a purchase, particularly, when money have been successfully withdrawn from the user's bank card, or the money withdrawal has failed (for instance, there is not enough funds on the card, or a withdrawal limit has been exceeded), then the mobile device displays a corresponding payment system (payment service) message to the user, as shown in FIG. 12.

In an exemplary embodiment, the “My Gifts” screen mentioned above may contain two folders, specifically: “My Coupons” and “Sent Coupons”. The “My Coupons” folder contains both the coupons that have been bought but not yet sent, and the coupons that have been received as gifts.

Please note that the coupons are ranked (particularly, listed) in such a way, so that the latest coupon (one that has just been bought by the user) is displayed first.

In an exemplary embodiment, when the user selects a digital coupon in the mobile application, the coupon is displayed for review. The user may then click the “Send” button to move to the digital coupon sending screen, as shown in FIG. 13.

Also note that the user of the mobile application (COUPONAPP) may send the digital coupon using the web link to the generated coupon. When the user selects “Copy”, the link to the digital coupon web page is copied to the mobile device clipboard. Then, the user may be notified that they should input the link from the clipboard into a message and send it to the other user (the intended receiver of the gift, i.e. the digital coupon). For instance, the user may copy this web link, e.g. into an e-mail message, or into a message to be sent via a messaging application, etc.

In an exemplary embodiments of the present invention, when the other user receives a message containing a digital coupon in the messaging application, the user is shown a visual representation of the goods or services associated with the coupon.

After the user has sent the digital coupon to the other user, said coupon is moved from “My Coupons” to the “Sent Coupons” folder. Please note that, in an exemplary embodiment, digital coupons are stored in the “Sent Coupons” folder both if a coupon has been sent successfully, and if the attempt to send the coupon has failed.

Please note that the user may also send a digital coupon from the “Sent Coupons” folder in the mobile application.

In an exemplary embodiment of the present invention, when a digital coupon in the “My Coupons” folder has been activated, the coupon goes dark, just as it would in case it expires.

Please note that digital coupons may be kept in memory (not removed) whatever the status. Also, digital coupons may be removed, particularly, by hiding them from the user, after a certain (pre-set) amount of time, e.g. 20, 30 days, etc. since they have expired or have been activated.

FIG. 14 shows an exemplary embodiment of the system to carry out the method of the present invention.

FIG. 15 shows an exemplary illustration of how the present system can be integrated with a payment service (payment system).

Please note that the device mentioned above, that is used by the goods or service seller to activate the digital coupon, comprises reading of codes disclosed herein; receiving the digital coupon data; paying for the order with digital coupons either completely or partially, wherein when a digital coupon is activated (particularly, to complete an order), this coupon is activated on the server 1422. If this activation is successful, the corresponding transaction is completed.

Also note that the seller may use a dedicated device to open an order creation or editing screen, and to scan the digital coupon code with the dedicated scanner, or photograph the code with the device's camera, and then recognize the code with the device's software.

Then, the software (particularly, the plugin) on said device sends a request to the server using authorization by login/password/seller's ID (or other parameters). The received code is used to retrieve the status of the coupon. After the coupon status has been retrieved, the software on said device informs the user of the device whether the coupon can be used, provided it hasn't been already activated. To activate a coupon, said software requests to input a unique PIN code (see above). In response to five failed PIN code input attempts, said software module (plugin) is temporarily blocked and will not be able to interact with the system. This block can be overridden by a specially appointed person, whose responsibility is to find out the reason of failed attempts.

Then, in response to a successful reply from the server 1422, said device displays a notification that an active digital coupon has been found, including goods or services associated with the coupon.

Also note that when the seller adds payment to the order using said device, a cashier screen is displayed, where the seller may select cashless mode of payment—with a digital coupon—for the goods or services. Then, the digital coupon code is scanned, as described above, after which, the device sends a query to the server 1422 to identify the digital coupon and obtain its data. The plugin mentioned above sends a request to said server via said relative path. In case the digital coupon is invalid, the seller's device notifies the seller of a failure, and the payment for goods or services is canceled (interrupted).

Please note that if a digital coupon is used to pay for the order (goods or services), particularly, when the seller selects the digital coupon payment option on said device, the plugin checks whether there are digital coupons in the order, the sum of digital coupons, and then pays for goods or services by activating the coupon. Also, when the digital coupon is activated, said device sends an HTTP query to the server 1422, wherein the query may contain the digital coupon PIN code, ID, seller or store ID, etc.

If the server 1422 replies that the digital coupon has been successfully activated, the order is completed.

In case there has been an error in activation (or the reply hasn't been received), the order is not completed, and the seller is notified of the error.

In some embodiments, to activate a coupon, the seller requires some data, specifically, a QR code and/or a bar code.

In some embodiments, the seller inputs the QR code or bar code into the seller's device using a camera or bar code scanner. The data in the QR code or bar code (digital coupon code) is decoded by the software installed on the seller's device.

In some embodiments, after the seller has inputted the QR code and/or bar code, the second user (receiver) tells the seller their activation PIN code.

In some embodiments, after the seller has inputted the QR code and/or bar code into their device, the device sends these data to the server, the server, in turn, checks whether the digital coupon in question really exists and is active, and, if the coupon in question exists and is active, the server sends the PIN code request to the seller's device. The seller requests the PIN code from the second user (receiver), inputs the code into the seller's device, which, in turn, sends these data to a server, then the server marks the digital coupon as activated and sends a notification of a successful coupon activation back to the seller's device, and finally, the seller sells the goods or services associated with the digital coupon. In the disclosed embodiment, PIN code is known only to the second user and is not known to other users (persons). The code may only be displayed upon the second user's request (e.g. by clicking the PIN code field, whereas by default, the entry in this field is hidden, e.g. replaced by a series of ***; or it may appear only after the seller's device has sent the data required for digital coupon activation to the server).

In conclusion, it should be noted that the details given in the description are examples that do not limit the scope of the present invention as defined by the claims. It is clear to a person skilled in the art that there may be other embodiments that are consistent with the spirit and scope of the present invention.

What is claimed is:

1. A method for buying a digital coupon and sending it to another user, the method comprising:
selecting an additional keyboard in a messaging application (MSGAPP), wherein the keyboard enables the first user to send digital coupons from their mobile device using a digital coupon management application (COUPONAPP) that is linked to the keyboard;
with said additional keyboard, selecting goods or services to buy a digital coupon for, that the user wants to send via the messaging application (MSGAPP);
paying for the goods or services via the COUPONAPP application on the mobile device, using a payment service, wherein the service notifies a server of a successful payment, then the server generates a digital coupon for the goods or services thus bought, stores the data required for sending the digital coupon, and sends these data to the first user's mobile device, into their COUPONAPP application, which, in turn, generates a link, based on the data received, the link connected to the generated digital coupon, and then the generated digital coupon link is sent via the messaging application (MSGAPP);
the second user receiving the digital coupon link via their MSGAPP application, either on a computer or a mobile device, then following this link to view the coupon data and possible places where the goods or services associated with the digital coupon can be obtained, and then providing the seller of said goods or services with the data required to activate the coupon and sell said goods or services; and
the seller inputting the data required to activate the coupon, into a seller's device, which, in turn, sends these data to a server, then the server marks the digital coupon as activated and sends a notification of a successful coupon activation back to the seller's device, and finally, the seller sells the goods or services associated with the digital coupon.

2. The method of claim 1, wherein the data that the seller requires to activate the coupon is stored as a QR code and/or bar code.

3. The method of claim 2, wherein the seller inputs the QR code or bar code into the seller's device using a camera or bar code scanner.
